(19) United States
(12) Patent Application Publication
(10) Pub. No.: US 2025/0077649 A1
(43) Pub. Date: Mar. 6, 2025

(54) INSTRUCTION MONITORING MODULE

(71) Applicant: STMicroelectronics International N.V., Geneva (CH)

(72) Inventor: Michael GIOVANNINI, Grenoble (FR)

(73) Assignee: STMicroelectronics International N.V., Geneva (CH)

(21) Appl. No.: 18/810,040

(22) Filed: Aug. 20, 2024

(30) Foreign Application Priority Data
Sep. 6, 2023 (FR) 2309347

(51) Int. Cl. G06F 21/54; G06F 21/55; G06F 21/85

(52) U.S. Cl. CPC G06F 21/54; G06F 21/554; G06F 21/85

(57) ABSTRACT

Provided is a module for monitoring instructions of a microcontroller. The module is adapted to receive instructions that are received at an input terminal of the microcontroller or that are being processed by a code pointer of the microcontroller. The module verifies the instructions received on the input terminal of the microcontroller or that are being processed by the code pointer of the microcontroller.

### CROSS-REFERENCE TO RELATED APPLICATION(S)

This application claims the priority benefit of French patent application number FR2309347, filed on Sep. 6, 2023, entitled “Module de surveillance d'instructions,” which is hereby incorporated by reference to the maximum extent allowable by law.

### BACKGROUND

### Technical Field

The present disclosure generally concerns electronic circuits and devices, and the protection of electronic circuits and devices against malicious attacks. The present disclosure more precisely concerns the protection of a complex electronic circuit such as processor or a microcontroller.

### Description of the Related Art

Complex electronic circuits are circuits adapted to implementing one or a plurality of complex functions, such as the performing of complex calculations based on received data and instructions. Processors and microcontrollers are complex electronic circuits, and are particularly adapted to receiving instructions, to decoding them, and to implementing them.

It would be desirable to be able to improve, at least partly, certain aspects of the protection of complex electronic circuits such as processors or microcontrollers.

### BRIEF SUMMARY

There exists a need for a more secure protection of complex electronic circuits, such as processors and microcontrollers.

There exists a need for a module for monitoring instructions received by a complex electronic circuit.

There exists a need for a module for monitoring instructions being processed by a complex electronic circuit.

An embodiment overcomes all or part of the disadvantages of instruction monitoring modules.

An embodiment overcomes all or part of the disadvantages of methods of monitoring instructions of a complex electronic circuit.

An embodiment overcomes all or part of the disadvantages of electronic devices comprising known complex electronic circuits.

An embodiment provides a module for monitoring instructions of a microcontroller, adapted to verifying instructions received on an input terminal of said microcontroller or instructions being processed by a code pointer of said microcontroller.

Another embodiment provides a method of verification of instructions of a microcontroller, implemented by a monitoring module, comprising a step of verification of the instructions received at an input terminal of said microcontroller or instructions being processed by a code pointer of said microcontroller.

According to an embodiment, if the verification indicates that the instructions are valid, then their reception or their processing may carry on.

According to an embodiment, if the verification indicates that the instructions are not valid, then the microcontroller is set to an error mode, or a secure mode or semi-secure mode.

According to an embodiment, the verification is implemented by a comparison of at least one data element corresponding to said instructions with a reference data element.

According to an embodiment, when the verification is a verification of the instructions received on said input terminal of said microcontroller, the reference data element is equal to data element “0xFFFFFFFF.”

According to an embodiment, when the verification is a verification of the instructions being processed by a code pointer of said microcontroller, the reference data element is equal to data element “0xF0000002.”

According to an embodiment, said input terminal of said microcontroller is a terminal of connection to a data bus.

According to an embodiment, the data bus is a communication bus of Advanced High-performance Bus type.

According to an embodiment, the data bus is a communication bus of Advanced extensible Interface type.

According to an embodiment, said instructions originate from a memory.

According to an embodiment, said memory is a non-volatile memory.

According to an embodiment, said memory is a flash-type RAM.

Another embodiment provides an electronic device comprising a previously-described module.

According to an embodiment, the device further comprises said microcontroller.

### BRIEF DESCRIPTION OF THE SEVERAL VIEWS OF THE DRAWINGS

The foregoing features and advantages, as well as others, will be described in detail in the rest of the disclosure of specific embodiments given by way of illustration and not limitation with reference to the accompanying drawings, in which:

FIG. 1 schematically shows in the form of blocks an example of a device adapted to including the embodiments described hereafter;

FIG. 2 schematically shows in the form of blocks an embodiment of a first monitoring module; and

FIG. 3 schematically shows in the form of blocks an embodiment of a second monitoring module.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “edge,” “back,” “top,” “bottom,” “left,” “right,” etc., or relative positions, such as terms “above,” “under,” “upper,” “lower,” etc., or to terms qualifying directions, such as terms “horizontal,” “vertical,” etc., it is referred, unless specified otherwise, to the orientation of the drawings.

Unless specified otherwise, the expressions “about,” “approximately,” “substantially,” and “in the order of” signify plus or minus 10%, preferably of plus or minus 5%.

The embodiments described hereafter concern the security of complex electronic circuits such as processors and microcontrollers receiving instructions. The embodiments described hereafter more particularly concern a module (e.g., circuit or controller) for monitoring instructions received or being processed by a complex electronic circuit, and the corresponding instruction monitoring method.

The monitoring module is particularly adapted to verifying that an instruction received or being processed, by the complex electronic circuit is valid. If such an instruction is not valid, then said monitoring module interrupts the reception and/or the processing of said instruction. The use of such a monitoring module enables to avoid malicious attacks consisting in the substitution of valid instructions by non-valid instructions enabling, for example, to modify the operation of the complex electronic circuit.

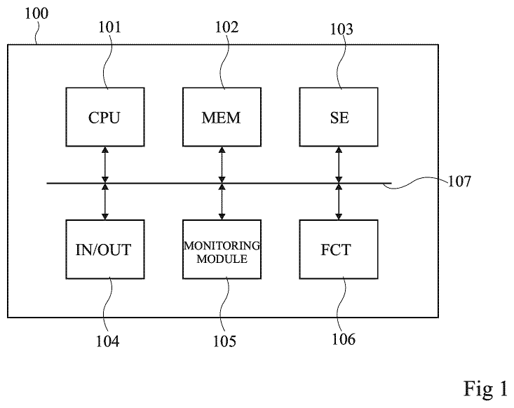

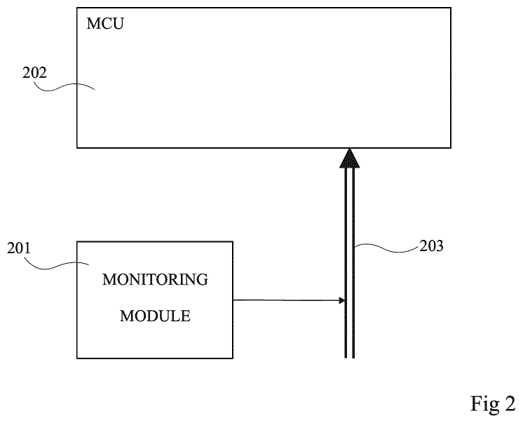

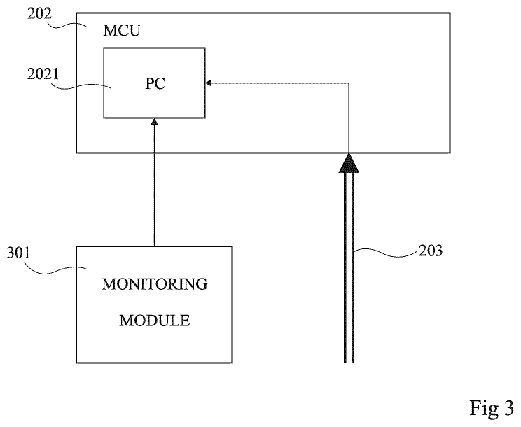

FIG. 1 is a block diagram schematically showing an architecture of an example of an electronic device 100 adapted to including the embodiments described in relation with FIGS. 2 and 3.

According to an embodiment, device 100 comprises a complex electronic circuit 101 (MCU) adapted to implementing different processings of data stored in memories and/or supplied by other circuits of device 100. According to an embodiment, complex electronic circuit 101 is a processor or a microcontroller. According to a preferred embodiment, circuit 101 is a microcontroller.

According to an example, device 100 may further comprise one or a plurality of memories 102 (MEM), for example memories of different types, among which, for example, a RAM, a non-volatile memory, a memory volatile, and/or a read-only memory. According to a preferred example, device 100 comprises at least one non-volatile memory and/or one flash-type RAM.

According to an example, device 100 may further comprise a secure element 103 (SE) adapted to processing critical and/or secret data. Secure element 103 may comprise its own processor(s), its own memory or memories, etc.

According to an example, device 100 may further comprise input/output circuits 104 (IN/OUT) adapted to enabling device 100 to communicate with one or a plurality of external electronic devices.

According to an embodiment, device 100 comprises a module (e.g., circuit or controller) for monitoring instructions 105 (MONITORING MODULE) received and/or being processed by complex circuit 101. Two embodiments of module 105 and their operations are described in detail in relation with FIGS. 2 and 3.

According to an example, device 100 may further comprise different circuits 106 (FCT2) adapted to performing different functions. As an example, circuits 106 may comprise measurement circuits, data conversion circuits, circuits for controlling electronic or electromechanical equipment, etc.

According to an embodiment, device 100 further comprises one or a plurality of data communication means 107 adapted to transferring data between the different electronic devices.

According to an embodiment, means 107 used to transmit data and instructions to complex circuit 101 are a communication bus of Advanced High-performance Bus (AHB) type, that is, an advanced high-performance bus intended for the communication, via a single channel, of circuits within an electronic system on chip.

According to another embodiment, means 107 used to transmit data and instructions to complex circuit 101 are a communication bus of Advanced extensible Interface (AXI) type, that is, an advanced extensible interface intended for the communication, via a plurality of channels, of circuits within an electronic system on chip.

FIG. 2 is a block diagram schematically showing a monitoring module 201 (Monitoring MODULE), of the type of the monitoring module 105 described in relation with FIG. 105, and a complex electronic circuit 202 (MCU), called microcontroller 202 hereafter, of the type of the complex electronic circuit 101 described in relation with FIG. 1.

Monitoring module 201 is adapted to monitoring the instructions received by microcontroller 202. More particularly, monitoring module 201 is adapted to receiving the received instructions that microcontroller 202 receives via a data bus 203. According to an embodiment, the instructions originate from a memory, such as for example, a non-volatile memory or a flash-type RAM.

Monitoring module 201 is further adapted to performing a verification of these instructions to determine whether the instructions are valid or not. It is here said that a valid instruction is a correct instruction intended for the microcontroller, and that a non-valid instruction is an instruction which is generated by a malicious person, and which is intended to obtain information relative to the operation of the microcontroller and/or to modify the behavior of the microcontroller.

According to an embodiment, the verification performed by module 201 is a comparison of the received instructions with known non-valid instructions. For this purpose, module 201 compares data forming the received instructions with reference data. According to an embodiment, module 201 compares the data of the instructions with hexadecimal data element “0xFFFFFFFF.”

If the result of the verification indicates that the instructions are valid, module 201 does not interrupt the reception of the instructions by microcontroller 202. Conversely, if the result of the verification indicates that the instructions are not valid, module 201 may set the microcontroller to an error mode or a secure or semi-secure mode, where the critical data, such as encryption and/or decryption keys, are made inaccessible. Further, module 201 may inform thereof another module adapted to processing errors.

Thus, a monitoring method implementing module 201 is the following. For each reception of instructions by microcontroller 202, a step of verification of these instructions is implemented by module 201 to verify the validity of the instructions. Module 201 interrupts, or not, the reception of the instructions according to the result of the verification.

FIG. 3 is a block diagram schematically showing a monitoring module 301 (Monitoring MODULE), of the type of the monitoring module 105 described in relation with FIG. 105, and the complex electronic circuit 202 (MCU) described in relation with FIG. 2.

Monitoring module 301 is adapted to monitoring the instructions being processed by microcontroller 202. More particularly, monitoring module 301 is adapted to receiving the instructions being processed that microcontroller 202 starts decoding by means of its code pointer 2021 (PC). Indeed, any instruction received by microcontroller 202 is, first, decoded by code pointer 2021, to then be effectively processed by one or a plurality of internal circuits of the microcontroller.

Like the module 201 of FIG. 2, monitoring module 301 is further adapted to performing a verification of these instructions to determine whether the instructions are valid or not.

According to an embodiment, the verification performed by module 301 is a comparison of the received instructions with known non-valid instructions. For this purpose, module 301 compares data forming the received instructions with reference data. According to an embodiment, module 301 compares the data of the instructions with hexadecimal data element “0xF0000002.”

If the result of the verification indicates that the instructions are valid, module 301 does not interrupt the decoding of the instructions by the code pointer 2021 of microcontroller 202. Conversely, if the result of the verification indicates that the instructions are not valid, module 301 prevents the decoding of the instructions by the code pointer 2021 of microcontroller 202.

Thus, a monitoring method implementing module 301 is the following. For each processing of instructions by microcontroller 202, that is, for each decoding of instructions by the code pointer 2021 of microcontroller 202, a step of verification of these instructions is implemented by module 301 to verify the validity of the instructions. Module 301 interrupts, or not, the reception of the instructions according to the result of the verification.

Various embodiments and variants have been described. Those skilled in the art will understand that certain features of these various embodiments and variants may be combined, and other variants will occur to those skilled in the art. In particular, a monitoring module combining the properties of the modules 201 of FIG. 2 and 301 of FIG. 3 is also envisaged.

Finally, the practical implementation of the described embodiments and variants is within the abilities of those skilled in the art based on the functional indications given hereabove.

Module for monitoring instructions (105; 201; 301) of a microcontroller (101; 202), may be summarized as including adapting to verifying instructions received on an input terminal of said microcontroller (101; 202) or instructions being processed by a code pointer (2021) of said microcontroller (101; 202).

Method of verification of instructions of microcontroller (101; 202), implemented by a monitoring module (105; 201; 301), may be summarized as including a step of verification of the instructions received at an input terminal of said microcontroller (101; 202) or instructions being processed by a code pointer (2021) of said microcontroller (101; 202).

If the verification indicates that the instructions are valid, then their reception or their processing may carry on.

If the verification indicates that the instructions are not valid, then the microcontroller may be set to an error mode, or a secure mode, or a semi-secure mode.

The verification may be implemented by a comparison of at least one data element corresponding to said instructions with a reference data element.

The verification may be a verification of the instructions received on said input terminal of said microcontroller (101; 202), the reference data element is equal to data element “0xFFFFFFFF.”

The verification may be a verification of the instructions being processed by a code pointer (2021) of said microcontroller (101; 202), the reference data element may be equal to data element “0xF0000002.”

Said input terminal of said microcontroller (101; 202) may be a terminal of connection to a data bus (107; 203).

The data bus may be a communication bus (107; 203) of Advanced High-performance Bus (AHB) type.

The data bus may be a communication bus (107; 203) of Advanced extensible Interface (AXI) type.

Said instructions may originate from a memory (102).

Said memory (102) may be a non-volatile memory.

Said memory (102) may be a flash-type RAM.

Electronic device may be summarized as including a module.

Device may further include said microcontroller (101; 202).

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A module for monitoring instructions of a microcontroller, comprising:
an input configured to receive instructions that are received at an input terminal of said microcontroller or that are being processed by a code pointer of said microcontroller; and
circuitry configured to verify the instructions that are received on the input terminal of said microcontroller or that are being processed by the code pointer of said microcontroller.

2. The module according to claim 1, wherein the microcontroller is configured to process the instructions in response to the module verifying the instructions.

3. The module according to claim 1, wherein the microcontroller is set to an error mode, a secure mode, or a semi-secure mode in response the verification by the module indicating that the instructions are not valid.

4. The module according to claim 1, wherein the circuitry is configured to verify the instructions by comparing at least one data element corresponding to said instructions with a reference data element.

5. The module according to claim 4, wherein when the instructions are received on said input terminal of said microcontroller, the reference data element is data element “0xFFFFFFFF.”

6. The module according to claim 5, wherein when the instructions are processed by the code pointer of said microcontroller, the reference data element is data element “0xF0000002.”

7. The module according to claim 1, wherein said input terminal of said microcontroller is a terminal having a connection to a data bus.

8. The module according to claim 7, wherein the data bus is a communication bus of Advanced High-performance Bus type.

9. The module according to claim 7, wherein the data bus is a communication bus of an Advanced extensible Interface (AXI) type.

10. The module according to claim 1, wherein said instructions originate from a memory.

11. The module or method according to claim 10, wherein said memory is a non-volatile memory.

12. The module or method according to claim 10, wherein said memory is a flash-type RAM.

13. A microcontroller comprising:
a module for monitoring instructions of the microcontroller, the module including:
an input configured to receive instructions that are received at an input terminal of said microcontroller or that are being processed by a code pointer of said microcontroller; and
circuitry configured to verify the instructions that are received on the input terminal of said microcontroller or that are being processed by the code pointer of said microcontroller.

14. The microcontroller according to claim 13, wherein the microcontroller is configured to process the instructions in response to the module verifying the instructions.

15. The microcontroller according to claim 13, wherein the microcontroller is set to an error mode, a secure mode, or a semi-secure mode in response the verification by the module indicating that the instructions are not valid.

16. The microcontroller according to claim 13, wherein the circuitry is configured to verify the instructions by comparing at least one data element corresponding to said instructions with a reference data element.

17. The microcontroller according to claim 16, wherein when the instructions are received on said input terminal of said microcontroller, the reference data element is data element “0xFFFFFFFF.”

18. A method, implemented by a monitoring module, for verification of instructions of a microcontroller, the method comprising:
receiving instructions that are received at an input terminal of said microcontroller or that are being processed by a code pointer of said microcontroller; and
verifying the instructions received at the input terminal of said microcontroller or that are being processed by the code pointer of said microcontroller.

19. The method according to claim 18, comprising:
processing, by the microcontroller, the instructions in response to the module verifying the instructions.

20. The method according to claim 18, wherein the microcontroller is set to an error mode, a secure mode, or a semi-secure mode in response the verification by the module indicating that the instructions are not valid.
